(19) United States
(12) Patent Application Publication
(10) Pub. No.: US 2024/0020107 A1
(43) Pub. Date: Jan. 18, 2024

(54) OPTIMIZED DEPLOYMENT OF UPDATES ACROSS COMPUTING SYSTEMS CONNECTED TO A WIDE AREA NETWORK (WAN)

(71) Applicant: VMware Inc., Palo Alto, CA (US)

(72) Inventors: Daniel James Beveridge, Valrico, FL (US); Erol Aygar, Maynard, MA (US)

(21) Appl. No.: 17/863,727

(22) Filed: Jul. 13, 2022

(51) Int. Cl. G06F 8/65

(52) U.S. Cl. CPC G06F 8/65

(57) ABSTRACT

The technology disclosed herein enables deployment of updates to computing systems connected to a Wide Area Network (WAN). In a particular example, a method includes identifying an update to be performed on computing systems connected to a Wide Area Network (WAN) and identifying first attributes of a first computing system of the computing systems. The method further includes determining an update time in which the update should be performed at the first computing system based on the first attributes relative to other attributes of other ones of the computing systems. The method also includes performing the update at the first computing system at the update time.

### TECHNICAL BACKGROUND

Patch management is a commonly used phrase to describe a process of distributing and applying updates (i.e., patches) to software. The updates may add features, fix bugs, remedy vulnerabilities, or change the software in some other manner. A Wide Area Network (WAN) is capable of connecting large numbers of computing systems operated/controlled by an entity (e.g., business). There is risk involved when software is updated because the software being updated, and any other software that relies upon the software being updated, will be unavailable during the update. Accounting for software being unavailable on a computing system can be difficult, if not impossible, when large numbers of computing systems are involved and need to be updated. Therefore, handling patch management on those computing systems can still lead to undesired outages affecting the performance of activities by the computing systems in the aggregate.

### SUMMARY

The technology disclosed herein enables deployment of updates to computing systems connected to a Wide Area Network (WAN). In a particular example, a method includes identifying an update to be performed on computing systems connected to a Wide Area Network (WAN) and identifying first attributes of a first computing system of the computing systems. The method further includes determining an update time in which the update should be performed at the first computing system based on the first attributes relative to other attributes of other ones of the computing systems. The method also includes performing the update at the first computing system at the update time.

In other examples, an apparatus performs the above-recited method and computer readable storage media directs a processing system to perform the above-recited method.

### BRIEF DESCRIPTION OF THE DRAWINGS

FIG. 1 illustrates an implementation for optimizing update deployments across WAN-connected computing systems.

FIG. 2 illustrates an operation to optimize update deployments across WAN-connected computing systems.

FIG. 3 illustrates an implementation for optimizing update deployments across SD-WAN edges.

FIG. 4 illustrates an SD-WAN edge in the implementation for optimizing update deployments across SD-WAN edges.

FIG. 5 illustrates an operation to optimize update deployments across SD-WAN edges.

FIGS. 6-10 illustrate update-time graphs for optimizing update deployments across SD-WAN edges.

FIG. 11 illustrates a computing system for optimizing update deployments across WAN-connected computing systems.

### DETAILED DESCRIPTION

The update services described herein optimize the deployment of software updates across computing systems connected to a WAN. Specifically, the deployment of a software update is optimized to reduce risk associated with downtime during the software update. The risk of a particular update relates to an impact of the downtime on activities (e.g., services) being performed by the affected software component(s). For instance, the computing systems of a particular entity may be providing a computing service over the WAN. If all the systems are updated at once, the entire service will be unavailable until the software update is complete. Thus, the update services herein performs software updates in a manner that avoids complete outage of any service/activity being performed by the computing systems being updated (e.g., update a subset of the computing systems while another subset remains active). If it is not possible to avoid a complete outage (either systemwide or in a particular region), then the update service performs the update when the outage will have less of an impact (e.g., when usage of the software is relatively low).

Moreover, it is prudent to update the systems in phases rather than all at once to avoid disruptions caused by a bad update (e.g., an update that includes a bug). For instance, if all systems providing a particular service are updated and that update prevents the systems from effectively providing the service, then the service is unavailable until the issue caused by the update is resolved. Thus, only updating a portion of the systems enables other systems providing the service to continue operating having not received the update. Should the update prove to be reliable, then the other systems can be updated as well. Similarly, updates to systems supporting more important activities (i.e., higher risk systems) may be performed after the updates have already proven themselves to be stable.

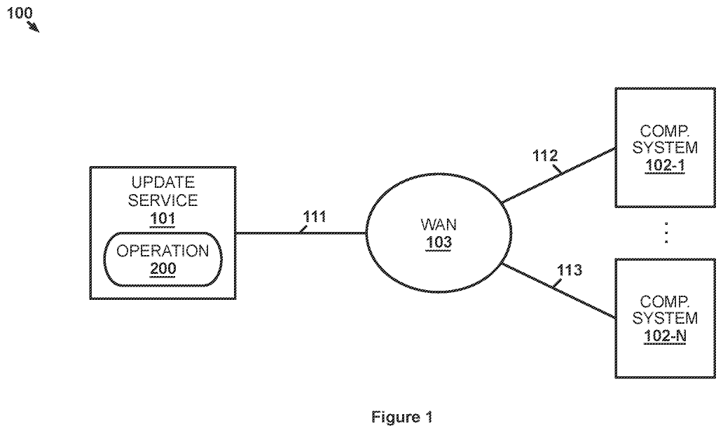

FIG. 1 illustrates implementation 100 for optimizing update deployments across WAN-connected computing systems. Implementation 100 includes update service 101, computing systems 102, and WAN 103. Update service 101 connects to WAN 103 over communication link 111. Computing system 102-1 connects to WAN 103 over communication link 112. Computing system 102-N connects to WAN 103 over communication link 113. Although not shown, others of computing systems 102 also connect to WAN 103 over similar communication links. Communication links 111-113 may be wired and/or wireless and, while shown as direct links, may include intervening systems, networks, and/or devices. WAN 103 includes network systems, devices, and communication links for exchanging communications over a large geographic area. In some examples, WAN 103 may include the Internet.

In operation, computing systems 102 execute software to perform activities thereon that involve communications over WAN 103 on behalf of an operating entity. For instance, computing system 102-1 may host a network application that is accessible over WAN 103. As with most modern software, the software executing on computing systems 102 will require updating at some point. The software may include applications, operating systems, virtualization software (e.g., hypervisors, container engines, container orchestration platforms, etc.), device firmware, or any other type of program instructions executing on computing systems 102 that can be updated over a network. While only two of computing systems 102 are shown, any number of computing systems may be included in computing systems 102. Also, each of computing systems 102 may be identical or computing systems 102 may include different types of computing systems (e.g., computing systems with different purposes, from different vendors, etc.). Update service 101 is implemented by one or more computing systems that may be similar in architecture to those of computing systems 102. Update service 101 may communicate with computing systems 102 over WAN 103, as shown, or may communicate over an out-of-band channel. Update service 101 is also operated by, or otherwise controlled by, the entity and optimizes updates to the software on computing systems 102 to reduce or remove any impact downtime caused by the updates. Operation 200 is performed by update service 101 to optimize when updates to computing systems 102 occur.

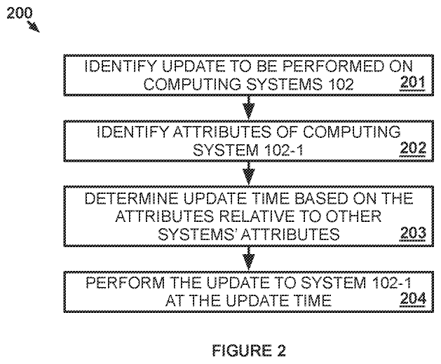

FIG. 2 illustrates operation 200 to optimize update deployments across WAN-connected computing systems. During operation 200, update service 101 identifies an update to be performed on computing systems 102 (201). In this example, the update is at least an update to computing system 102-1 but may also be applicable to others of computing systems 102. The update may be identified in different ways depending on how updates are performed by update service 101. For instance, the update itself (i.e., the instructions that comprise the update) may be received at update service 101 (e.g., from a distributing system) or computing system 102-1 may notify update service 101 that it has received the update. Alternatively, update service 101 may be notified that the update is available for retrieval either from a distributer of the update or from computing system 102-1 without receiving the actual update. In such examples, the update may not be retrieved by update service 101, or by computing system 102-1 directly, until the update is ready to be applied.

Update service 101 also identifies attributes of computing system 102-1 (202). The attributes may include computing system 102-1's system type (e.g., hardware specs, manufacturer, model number, etc.), an amount of WAN 103 bandwidth managed by computing system 102-1, an average utilization of that bandwidth by computing system 102-1, the geographic location of computing system 102-1, a business unit associated with computing system 102-1 or software executing thereon that will be affected by the update (i.e., subject to the update itself or will otherwise be down during the update), the current patch level of the software being updated, status of workloads executing on computing system 102-1 (e.g., activities being performed by the software being updated or by other software that will be affected by the update), or any other type of information that may be pertinent to when update service 101 determines the update should be applied. In some examples, the attributes may be what indicate which of computing systems 102 are executing the software to which the update will be applied but update service 101 may identify those computing systems in some other manner. A portion of the attributes may be received from computing system 102-1 itself via some other system monitoring computing system 102-1. For example, computing system 102-1 may report on the status of workloads thereon or another system controlling the workloads may report the status. A portion of the attributes may be calculated by update service 101 itself based on previous attributes received (e.g., to calculate average bandwidth utilization). A portion of the attributes may be received from other components managing computing systems 102 or information received from a user. For instance, update service 101 may be a component of a control plane that manages computing systems 102 and maintains information about computing systems 102, such as their business unit, geographic location, etc. Update service 101 need not wait until an update is identified to receive the attributes. Rather, attributes may be received periodically to ensure they are up to date whenever an update is received.

Update service 101 determines an update time in which the update should be performed at computing system 102-1 based on the attributes of computing system 102-1 relative to other attributes of other ones of computing system 102-1 (203). The attributes of the other computing systems may be similar to those described above for the attributes of computing system 102-1 and may, likewise, be received by update service 101 in a similar manner. The attributes of the other computing systems are considered to better ensure computing system 102-1 is updated at a time that causes a minimal impact to the operations of computing systems 102 in the aggregate. For instance, computing system 102-1 may be one of two or more computing systems that provide a service in a particular geographic region (e.g., in a particular country). Update service 101 may choose an update time that ensures computing system 102-1 is not updated at the same time as the other computing systems in region so that all of the computing systems providing the service to the region are not down at once (e.g., if they all were down at the same time, the service may either not be provided in that region during the downtime or the service may be provided by systems outside of the region, which may introduce undesired latency or improper regional-specific service). In a similar example, update service 101 may determine a timeframe when the load on computing system 102-1 is at a relatively low level and then select that update time from within that timeframe. Other factors and combinations of factors may be considered in other examples.

In some examples, update service 101 may factor other updates that have yet to be performed on computing system 102-1 when determining the update time. For instance, the update of this present operation may be at a higher level of the software stack executing on computing system 102-1 than a second update for which update service 101 is also determining an update time. When update service 101 performs the second update, the software to be updated by the present update will also be affected. So that software does not have to be affected twice (i.e., due to the performance of the two updates at different times), update service 101 may determine a single update time to perform both updates. While only software/firmware updates have been discussed thus far, update service 101 may also be able to schedule update times for hardware components of computing system 102-1 (e.g., may receive notification from a technician that a component will be changed and respond to the technician with a time to take computing system 102-1 offline to perform the change). Similarly, even if update service 101 is not used to schedule a hardware update, update service 101 may determine when an update has occurred (e.g., by receiving updated computing system 102-1 attributes) and perform the update when computing system 102-1 is back online (i.e., to extend the downtime that has already occurred due to the hardware change).

In some examples, the update time for computing system 102-1 may be dependent upon a risk score determined for computing system 102-1 by update service 101. For instance, the risk score may represent risk on a numeric scale (e.g., 1-10) with one end of the scale representing higher risk and the other representing lower risk. The risk score may be determined from at least a subset of the attributes of computing system 102-1. The risk score indicates an impact on computing systems 102 should the operation of computing system 102-1 be disrupted by the update (e.g., the update may include a bug that prevents computing system 102-1 from performing properly). For example, if the update affects a workload on computing system 102-1 that is very important to a critical business unit or is critical to the operations of other workloads on computing systems 102, then the risk score may be set relatively high compared to less important workloads or workloads for less important business units.

Update service 101 similarly determines a risk score for others of computing systems 102 that will also be updated. Update service 101 determines a relative risk of computing system 102-1 relative to those other computing systems. The relative risk indicates how risky it is to update computing system 102-1 relative to how risky it is to update others of computing systems 102. Generally, update service 101 will apply the update to computing systems with lower relative risk before those having higher relative risk. Update service 101 may apply an update policy that specifically defines when computing systems should be updated based on risk. For example, the policy may define that a certain percentage of the computing systems having the lowest relative risk should be updated first followed by one or more groups of higher relative risk computing systems. It is also possible for the relative risk to be equal across computing systems. Update service 101 may still stagger updates to those computing systems to ensure a defective update does not take down all systems at once, as already discussed above. While the update policy may define update groups for computing systems 102 to stagger performance of the update, update service 101 still determines a best fit update time for computing system 102-1 within whichever group the policy places computing system 102-1. For instance, update service 101 may determine that computing system 102-1 has a low relative risk and is in the first update group. All computing systems in that first update group may be updated over the course of a day, with update service 101 selecting an update time for computing system 102-1 within that day, and then update service 101 may allow a few days to pass (e.g., to allow time to identify bugs) before starting updates to a second update group defined by the policy.

After update service 101 has determined the update time for computing system 102-1, update service 101 performs the update at computing systems 102-1 at the update time (204). To perform the update, update service 101 may transfer the program instructions comprising the update to computing system 102-1 (e.g., in a file) and instruct computing system 102-1 to implement the update. Alternatively, update service 101 may instruct computing system 102-1 to perform the update at the update time in examples where computing system 102-1 retrieves the update program instructions itself. Other manners of performing the update at computing system 102-1 may also be used at the time instructed by update service 101. Update service 101 similarly performs the update at other ones of computing systems 102 at update times determined for each respective one of those other systems. By coordinating the update times across all computing systems 102, the impact of the updated software being down during the update is minimized by update service 101.

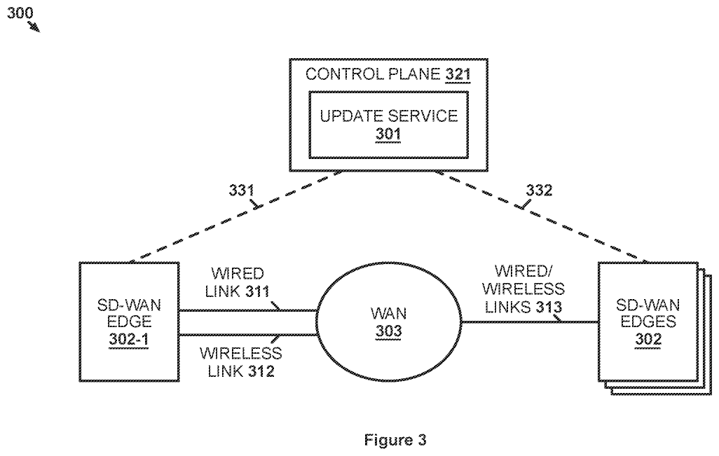

FIG. 3 illustrates implementation 300 for optimizing update deployments across SD-WAN edges. Implementation 300 includes Software-Defined WAN (SD-WAN) edges 302, which include Software-Defined WAN edge 302-1, WAN 303, and control plane 321. Update service 301 is a component of control plane 321 and handles updates to SD-WAN edges 302. SD-WAN edge 302 is connected to WAN 304 via wired link 311 and wireless link 312. SD-WAN edges 302 also each respectively connect to WAN 304 using a wired and a wireless link of wired/wireless links 313. Control plane 321 connects to SD-WAN edges 302-1 over out-of-band link 331 and to the remainder of SD-WAN edges 302 over out-of-band links 332. Out-of-band link 331 and out-of-band links 332 are out of band in the sense that they are not part of a software defined WAN created by SD-WAN edges 302 being connected over WAN 303. Out-of-band link 331 and out-of-band links 332 may still carry communications over some of the physical networking hardware of WAN 303.

In operation, SD-WAN edges 302 may be operated by an entity. A typical SD-WAN setup enables those of SD-WAN edges 302 located at branch sites of the entity to communicate with one or more of SD-WAN edges 302 located at a data center for the entity. SD-WAN edges 302 are also able to communicate with cloud services (not shown) over WAN 303. Each of SD-WAN edges 302 determines which of their respective wired/wireless links 313 should be used for any given traffic (e.g., one link may be down, overloaded, or otherwise unable to properly send data and the other link may be used instead). SD-WAN edges 302 may simply be gateways to WAN 303 for other computing systems at their respective sites or may execute processes thereon that communicate over WAN 303 (e.g., provide a service over WAN 303). Other examples may include more than just two redundant connections to WAN 303. Similarly, in some examples, SD-WAN edges 302 may include connections that do not travel through WAN 303. For instance, a Multi-Protocol Label Switching (MPLS) may connect one or more of the SD-WAN edges 302 located at a branch site to one of SD-WAN edges 302 located at the data center. Those of SD-WAN edges 302 at branch sites may then also select the MPLS link to data being sent to the data center instead of sending the data over one of wired/wireless links 313. Like out-of-band link 331 and out-of-band links 332, the MPLS links may be carried by networking hardware also used by WAN 303.

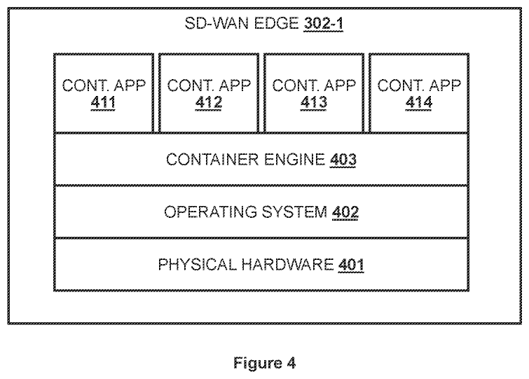

FIG. 4 illustrates SD-WAN edge 302-1 in implementation 300 for optimizing update deployments across SD-WAN edges. Other edges in SD-WAN edges 302 may include similar architectures to that of SD-WAN edge 302-1 or may use different architectures. SD-WAN edge 302-1 includes physical hardware 401. Physical hardware 401 may include processing circuitry (e.g., one or more central processing units, graphic processing units, data processing units, etc.), communication circuitry (e.g., one or more wired networking interfaces, wireless network interfaces, etc.), volatile memory (e.g., Random Access Memory (RAM)), non-volatile memory (e.g., one or more solid state drives, hard disk drives, Read Only Memory (ROM), etc.), or some other type of physical computing component—including combinations thereof. Different layers of software, referred to as a computing stack, are executing on physical hardware 401. Those illustrated lower in the stack (i.e., closer to physical hardware 401) are dependent on those above to operate. If a software element lower in the stack is taken down to perform an update, all software above that element also goes down. In this example, container engine 403 runs on operating system 402 and containerized applications 411-414 run on container engine 403. Although not shown for clarity, other types of software may also be executing on physical hardware 401 at various layers in the compute stack, such as a container orchestration platform (e.g., Kubernetes) or firmware for components of physical hardware 401.

In this example, SD-WAN edge 302-1 executing containerized applications 411-414, which themselves work independently, or together, to provide one or more services over WAN 303. SD-WAN edge 302-1 may be dedicated to supporting the activities of containerized applications 411-414 or may also act as a gateway to WAN 303 for other computing systems co-located with SD-WAN edge 302-1. Containerized applications are application executing within containers provided by container engine 403. Container engine 403 is software that virtualizes operating system resources between the containerized applications executing thereon, which are containerized applications 411-414 in this example. While this example focuses on containerized applications, it should be understood that other types of applications may also be updated using similar mechanisms. For example, a computing system may execute applications in virtual machines or natively on operating system 402.

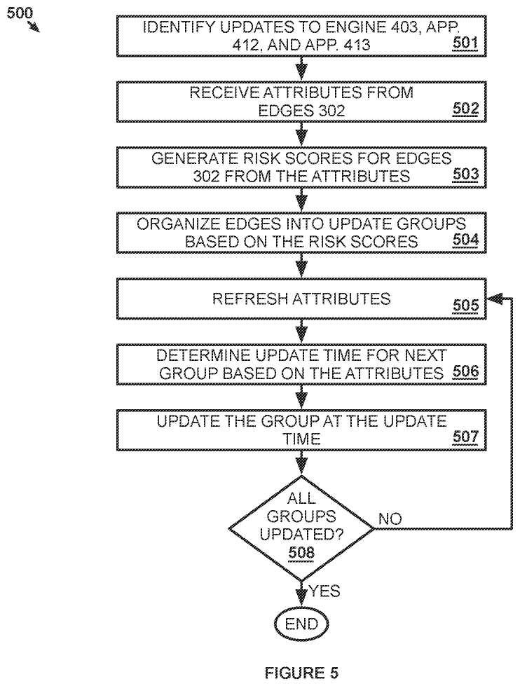

FIG. 5 illustrates operation 500 to optimize update deployments across SD-WAN edges. Operation 500 describes how update service 301 controls software updates to SD-WAN edges 302 (or at least to those edges of SD-WAN edges 302 that include the software being updated). In this example, update service 301 identifies updates to container engine 403, containerized application 412, and containerized application 413 (501). All three updates may be identified at substantially the same time or subsequent updates may be identified prior to update service 101 performing a previously received update. For instance, update service 101 may receive the update to containerized application 412 first and determine update times for those of SD-WAN edges 302 on which containerized application 412 should be updated. Before update service 101 can actually perform the update, update service 101 may identify the update to container engine 403. Attributes of SD-WAN edges 302 indicate to update service 301 that, when container engine 403 is updated, any containerized application running thereon will stop running, or go down, during the update process. Based on those attributes, update service 301 determines that it would be beneficial to update container engine 403 and containerized application 412 at substantially the same time. A similar determination may be made when an update to containerized application 413 is then also received. In some examples, update service 101 may wait for additional updates to be received after receiving a single update to reduce downtime during updates. For example, a software provider may specify that an update should be installed by a certain date (e.g., within the next two weeks). If update service 301 determines that there will be multiple beneficial update times for the update prior to that date, then update service 301 may wait for other updates to potentially be received that could be performed at the same time.

Update service 301 also receives attributes from SD-WAN edges 302 (502). At least a portion of the attributes that will be used by update service 301 to determine an update time may already be accessible to update service 301 (e.g., stored by update service 301 or otherwise accessible through control plane 321). The attributes may be received at any time even though they are shown as being received after the updates are identified. In some examples, all attributes needed by update service 301 to determine update times may already be available to update service 301 and retrieval from SD-WAN edges 302 is unnecessary. Similarly, in some examples, update service 301 may receive updates to attributes that may change over time to ensure the attributes being considered for update times are up to date. For example, the WAN traffic bandwidth being handled by SD-WAN edge 302-1 over time may change (e.g., while SD-WAN edge 302-1 may have been handling a large amount of bandwidth before an update may show that the amount has fallen off recently).

In operation 500, rather than converting the attributes directly into an update time, update service 301 generates risk scores for SD-WAN edges 302 from the attributes (503). Indicates the impact on the entity, or a division within the entity (e.g., business unit), should software affected by the update (i.e., the software being updated or other software that will also not function during the update), or the edge as a whole, be adversely affected by the update. As an example, if SD-WAN edge 302-1 provides a vital service on behalf of a business unit, then update service 301 may consider SD-WAN edge 302-1 a high-risk edge and provide an appropriate risk score for that level of risk. For instance, update service 301 may assign SD-WAN edge 302-1 a risk score of 8 out of 10, with 10 being the riskiest, due to SD-WAN edge 302-1's importance but also not going closer to 10 because the attributes of SD-WAN edges 302 may have indicated a backup to SD-WAN edge 302-1 in SD-WAN edges 302 that may be able to handle duties while SD-WAN edge 302-1 is down for updating.

Update service 301 organizes SD-WAN edges 302 into update group based on their respective risk scores (504). Update service 301 may apply an update policy to form the groups. The update policy may use any convention for organization but, preferably, the lowest risk of SD-WAN edge 302-1 are updated first (e.g., those closest to 1 on the above-mentioned scale from 1-10). If an issue occurs during the update or is caused by the update (e.g., a bug in the update), updating lower risk edges first reduces impact to the entity from that which may have occurred had higher risk edges been updated first. Similarly, the update policy may update a relatively small number of edges first to minimize the impact of any potential update-related issues.

In this example, prior to determining update for each of the edges in a first update group, update service 301 refreshes the attributes of those edges in the first update group (505). Refreshing the attributes again ensures the most up to date information is being used to determine an optimal update time for each edge. Since the first group may be updated close enough in time to when the attributes were received above, refreshing the attributes at this point may not be necessary in some cases. Update service 301 uses the attributes to determine when the first group of SD-WAN edges 302 should be updated (506). In some examples, update service 301 may determine that every edge in the group can be updated at the same time. In other examples, update service 301 may determine different update times for at least a portion of the edges in the group. For instance, while the attributes of one edge may enable it to be updated during the day, another edge may need to be updated overnight. In another example, update service 301 may recognize that applying the update to all edges in the first group at the same time will cause all instances of containerized application 412 in a particular geographic region to go down at the same time. Since that may not be desirable (e.g., in accordance with an update policy defining allowed/disallowed update conditions), update service 301 may stagger the updates to ensure a required number of containerized application 412 instances remain operational at any given time. Update service 301 performs the updates at each of the first group of SD-WAN edges 302 at the respective update times determined above (507). In some examples, all three of the updates may not be performed at exactly the same time due to certain updating needing to be performed sequentially. For instance, it may not be possible for containerized applications to be updated at the same time as container engine 403. Update service 301 may then update containerized application 412 and containerized application 413 just before or just after container engine 403 to minimize the instances in which those applications go down.

After performing the updates, update service 301 determines whether all groups of SD-WAN edges 302 have been updated (508). If yes, update service 301 ends operation 500 and waits until another update is identified to restart the process. In this case, since update service 301 has only updated the first group, update service 301 repeats step 505 on the next group of edges to refresh the attributes of the edges in the next group prior to determining update times for edges in that group. In some examples, update service 301 may wait a period of time before refreshing attributes due to a desired waiting period (e.g., indicated by an update policy) for determining whether issues occurred due to the update in the previously updated group. If an issue did occur, update service 301 may be notified to hold off on performing further updates until a solution is found. In those examples, update service 301 may proceed with determining update times for software not affected (e.g., if the issue was caused in containerized application 412's update, update service 301 may continue its update process for the updates to container engine 403 and containerized application 413). Waiting to refresh the attributes means that, when the time comes to determine update times for the next group, the attributes on which those update times are based will be up to date. After refreshing the attributes, update service 301 determines update times for the next group (506) and updates the edges in the group at those times (507). Update service 301 again determines whether any groups remain to be updated and, if there are groups, update service 301 repeats steps 505-508 according.

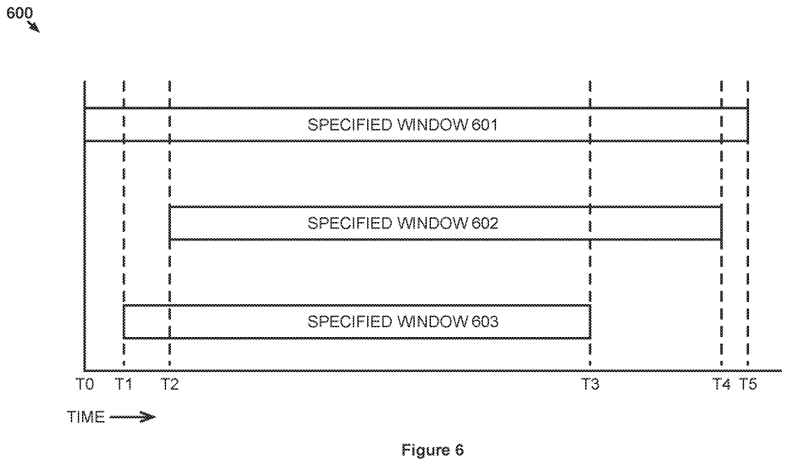

FIG. 6 illustrates update-time graph 600 for optimizing update deployments across SD-WAN edges. Update-time graph 600 is a visualization of time ranges from which update service 301 can determine update times for container engine 403, containerized application 412, and containerized application 413, as described with respect to operation 500. In this example, each update has a specified time window in which it is supposed to be performed. Specified window 601 is the window for the update to container engine 403, specified window 602 is the window for the update to containerized application 412, and specified window 603 is the window for the update to containerized application 413. T0, T1, and T2 may represent when the respective updates were identified by update service 301. T3, T4, and T5 represent a deadline for performing the respective updates. Specified windows 601-603 may be supplied by the entity or entities supplying the respective software updates or update service 301 may obtain the windows from some other source. In other examples, update service 301 may be directed by an update policy to perform the update as soon as update service 301 determines is best without any deadline for completion. Since specified windows 601-603 overlap, update service 301 determines that the updates can be performed to an edge at substantially the same time to minimize downtime. Specifically, specified window 601 corresponds to the update to container engine 403, which will cause containerized applications 411-414 to go down during that update. As such, the updates to containerized application 412 and containerized application 413 can also be performed at substantially the same time to reduce the number of instances in which containerized application 412 and containerized application 413 go down due to updates.

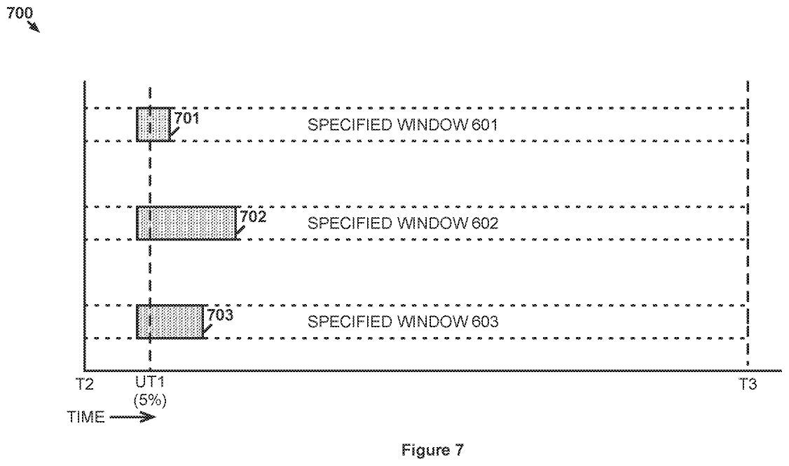

FIG. 7 illustrates update-time graph 700 for optimizing update deployments across SD-WAN edges. In this example, an update policy indicates that only 5% of SD-WAN edges 302 (i.e., 5% of those edges to which all three updates are being applied) should be updated in the first group, 20% in the next group, 70% in the next group, and then the final 5% in the last group. Each group includes edges having lower (or equivalent) risk scores relative to edges in subsequent groups. This example assumes that each update will follow the same update policy regarding percentages in each group but, in other examples, the percentages may be different for different updates and update service 301 will account for that difference (e.g., the update to containerized application 312 may be split into only two groups rather than four). Update service 301 determines that specified windows 601-603 overlap between T2 and T3, as shown in update-time graph 700. Update service 301 then begins determining the four update times that will be required to update all of the applicable edges in SD-WAN edges 302 on the schedule provided by the policy. As such, update service 301 first determines update timeframes 701-703 in each respective window based on the attributes determined during operation 500. Update time, UT1, is determined to be at a point when update timeframes 701-703 overlap. In some examples, UT1, and the other update times below, may be selected as the time when the timeframes begin to overlap (not the case here since UT1 is after), may be selected arbitrarily from within the overlap, may be selected based on attributes (e.g., bandwidth utilization) similar to those used to determine the update timeframes 701-703 (e.g., while the entire timeframe overlap may be acceptable for an update, a particular time within the timeframe may be best), or may be selected based on some other logic. In this example, update service 301 updates the 5% of edges being updated in the first group all at UT1. In other examples, update service 301 may distribute the updating across the overlap, which may depend on attributes of individual edges (e.g., the amount of traffic being serviced by one edge may be low, and optimal for performing an update, at a different time than another edge). Also, in some examples, update service 301 may provide the edges with the overlap timeframe and let the edges update on their own schedule within that timeframe (i.e., provide an edge with a maintenance window and allow the edge to update anytime within that maintenance window).

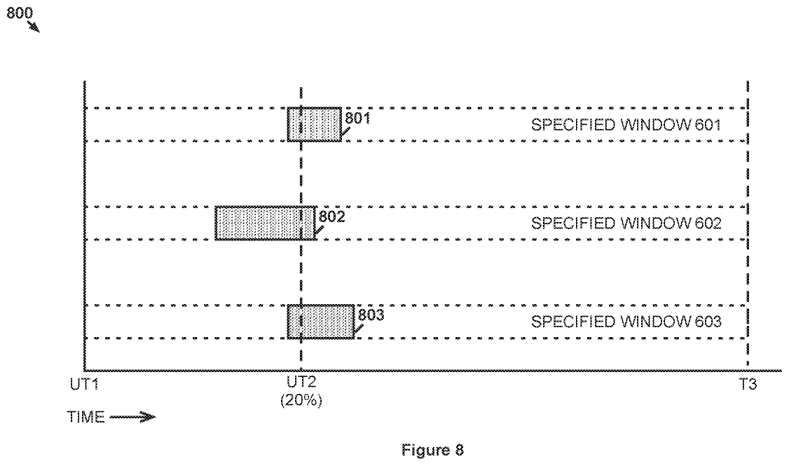

FIG. 8 illustrates update-time graph 800 for optimizing update deployments across SD-WAN edges. Update-time graph 800 shows the results of another iteration of steps 505-507 after the first group is updated at UT1. Update-time graph 800 shows that update time, UT2, is determined after UT1 to update the second group comprising 20% of edges that are higher or equal risk to those in group 1. Like in update-time graph 700, UT2 is determined from where update timeframes 801-803, which are determined by update service 301, overlap. As was explained with respect to update-time graph 700 above (and also applies to the examples below), all edges in the group may be updated at UT2 or other schedules may be used (e.g., distributing the updates throughout the overlap window, providing the edges with the overlap window to update on their own, etc.)

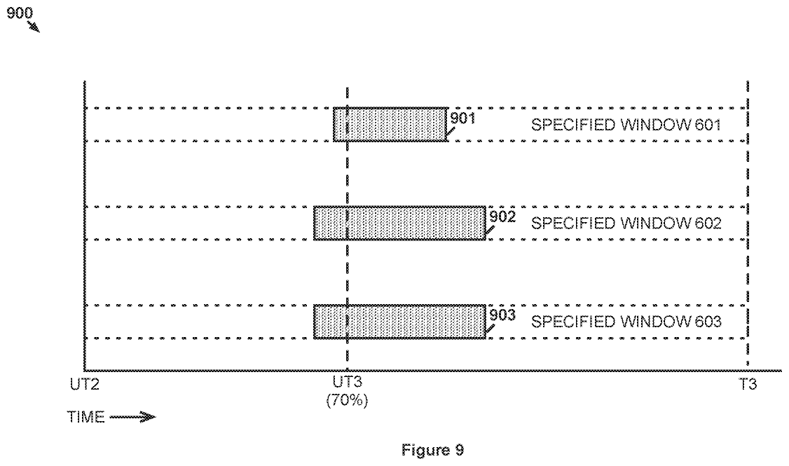

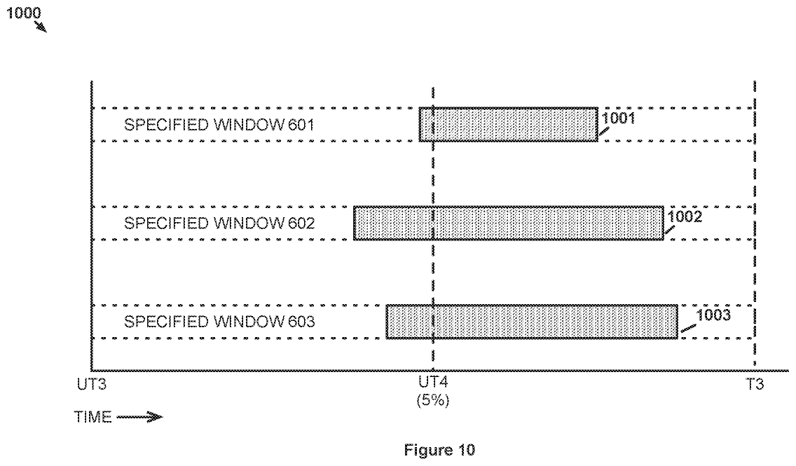

FIGS. 9-10 illustrate update-time graphs 900 and 1000 for optimizing update deployments across SD-WAN edges. Update-time graph 900 and update-time graph 1000 visualize two further iterations of steps 505-507 to update the 70% group at UT3 and the remaining 5% group at UT4. UT3 is selected by update service 301 from within update timeframes 901-903 and UT4 is selected by update service 301 from within update timeframes 1001-1003. After completion of the updates at UT4, all of SD-WAN edges 302 that were to have all three updates applied will have been updated. In some examples, others of SD-WAN edges 302 may only receive one or two of the updates (e.g., may not be running containerized application 413, so they do not receive that update) or may receive a completely different set of one or more updates. Update service 301 may factor in the update times determined for those updates as well when determining update times UT1-4. If update service 301 does not consider those other edges being updated, then an update policy may be violated (e.g., all instances of containerized application 412 may go down in a geographic region despite the update policy indicating that should not happen). In some cases, the update times for those other edges may be considered along with those shown in update-time graphs 600-1000. For example, if other edges are only receiving updates to containerized application 412 and container engine 403, then update service 301 may be able to update those edges at the same update times since the lack of containerized application 413 may not matter.

Also, while there is only one overlap period in each of the update-time graphs above, multiple overlaps may exist. For instance, update timeframe 902 may be split into multiple segments rather than being one contiguous period. It should further be understood, that when determining the update timeframes for each update, update service 301 also considers the impact on other software not being updated. In the case of SD-WAN edge 302-1, containerized application 411 and containerized application 414 are not being updated. Update service 301 also factors in attributes of those applications, which will have to go down when container engine 403 is updated. While the above examples only discuss updates to container engine 403 and containerized applications thereon, other examples may involve fewer/additional or different layers, such as operating system 402, a container orchestration platform, firmware, or physical hardware 401. In any example, update service 301 will always be aware of the effect updating one layer will have on another.

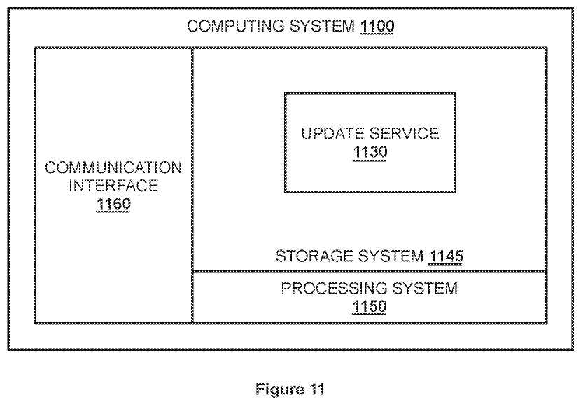

FIG. 11 illustrates computing system 1100 for optimizing update deployments across WAN-connected computing systems. Computing system 1100 is representative of any computing system or systems with which the various operational architectures, processes, scenarios, and sequences disclosed herein for an update service can be implemented. Computing system 1100 is an example architecture for update services 101 and 301, although other examples may exist. Computing system 1100 includes storage system 1145, processing system 1150, and communication interface 1160. Processing system 1150 is operatively linked to communication interface 1160 and storage system 1145. Communication interface 1160 may be communicatively linked to storage system 1145 in some implementations. Computing system 1100 may further include other components such as a battery and enclosure that are not shown for clarity.

Communication interface 1160 comprises components that communicate over communication links, such as network cards, ports, radio frequency (RF), processing circuitry and software, or some other communication devices. Communication interface 1160 may be configured to communicate over metallic, wireless, or optical links. Communication interface 1160 may be configured to use Time Division Multiplex (TDM), Internet Protocol (IP), Ethernet, optical networking, wireless protocols, communication signaling, or some other communication format—including combinations thereof. Communication interface 1160 may be configured to communicate with one or more web servers and other computing systems via one or more networks.

Processing system 1150 comprises microprocessor and other circuitry that retrieves and executes operating software from storage system 1145. Storage system 1145 may include volatile and nonvolatile, removable, and non-removable media implemented in any method or technology for storage of information, such as computer readable instructions, data structures, program modules, or other data. Storage system 1145 may be implemented as a single storage device but may also be implemented across multiple storage devices or sub-systems. Storage system 1145 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no examples would storage media of storage system 1145, or any other storage medium herein, be considered a transitory form of signal transmission (often referred to as “signals per se”), such as a propagating electrical or electromagnetic signal or carrier wave.

Processing system 1150 is typically mounted on a circuit board that may also hold the storage system. The operating software of storage system 1145 comprises computer programs, firmware, or some other form of machine-readable program instructions. The operating software of storage system 1145 comprises update service 1130. The operating software on storage system 1145 may further include an operating system, utilities, drivers, network interfaces, applications, or some other type of software. When read and executed by processing system 1150 the operating software on storage system 1145 directs computing system 1100 to operate update services as described herein.

In at least one implementation, update service 1130 directs processing system 1150 to identify an update to be performed on computing systems connected to a Wide Area Network (WAN) and identify first attributes of a first computing system of the computing systems. Update service 1130 further directs processing system 1150 to determine an update time in which the update should be performed at the first computing system based on the first attributes relative to other attributes of other ones of the computing systems. Update service 1130 also directed processing system 1150 to perform the update at the first computing system at the update time.

The included descriptions and figures depict specific implementations to teach those skilled in the art how to make and use the best mode. For teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method comprising:
identifying an update to be performed on computing systems connected to a Wide Area Network (WAN);
identifying first attributes of a first computing system of the computing systems;
determining an update time in which the update should be performed at the first computing system based on the first attributes relative to other attributes of other ones of the computing systems; and
performing the update at the first computing system at the update time.

2. The method of claim 1, wherein determining the update time comprises:
generating a first risk score from the first attributes, wherein the risk score indicates an impact on the computing systems should the update disrupt operation of the first computing system;
determining a relative risk of the first risk score relative to other risk scores of the other computing systems; and
setting the update time to correspond to the relative risk.

3. The method of claim 2, wherein setting the update time comprises:
applying an update policy to the relative risk, wherein the update policy indicates that lower-risk computing systems of the computing systems should be updated before higher-risk computing systems, and wherein the lower-risk computing systems have lower relative risks to the higher-risk computing systems.

4. The method of claim 1, wherein the first attributes include a geographic location of the first computing system, and wherein determining the update time comprises:
setting the update time to be different than update times of one or more of the computing systems having the geographic location.

5. The method of claim 1, wherein determining the update time comprises:
identifying an update-time window within which the update should be performed at the first computing system, wherein the update time is selected from within the update-time window.

6. The method of claim 5, comprising:
identifying a second update to be performed at the first computing system;
identifying a second update-time window within which the second update should be performed at the first computing system;
identifying a time overlap between the update-time window and the second update-time window; and
setting the update time from within the time overlap.

7. The method of claim 6, comprising:
performing the second update at the first computing system at the update time.

8. The method of claim 6, wherein the update is applied to a different layer of a compute stack executing on the first computing system than the second update.

9. The method of claim 6, comprising:
during the update-time window, waiting to set the update time until one or more other updates to be performed at the first computing system are identified.

10. The method of claim 1, wherein the first computing system comprises a Software-Defined WAN (SD-WAN) edge.

11. One or more computer readable storage media having program instructions stored thereon that, when read and executed by a processing system, direct the processing system to:
identify an update to be performed on computing systems connected to a Wide Area Network (WAN);
identify first attributes of a first computing system of the computing systems;
determine an update time in which the update should be performed at the first computing system based on the first attributes relative to other attributes of other ones of the computing systems; and
perform the update at the first computing system at the update time.

12. The storage media of claim 11, wherein to determine the update time, the program instructions direct the processing system to:
generate a first risk score from the first attributes, wherein the risk score indicates an impact on the computing systems should the update disrupt operation of the first computing system;
determine a relative risk of the first risk score relative to other risk scores of the other computing systems; and
set the update time to correspond to the relative risk.

13. The storage media of claim 12, wherein to set the update time, the program instructions direct the processing system to:
apply an update policy to the relative risk, wherein the update policy indicates that lower-risk computing systems of the computing systems should be updated before higher-risk computing systems, and wherein the lower-risk computing systems have lower relative risks to the higher-risk computing systems.

14. The storage media of claim 11, wherein the first attributes include a geographic location of the first computing system, and wherein to determine the update time, the program instructions direct the processing system to:
set the update time to be different than update times of one or more of the computing systems having the geographic location.

15. The storage media of claim 11, wherein to determine the update time, the program instructions direct the processing system to:
identify an update-time window within which the update should be performed at the first computing system, wherein the update time is selected from within the update-time window.

16. The storage media of claim 15, wherein the program instructions direct the processing system to:
identify a second update to be performed at the first computing system;
identify a second update-time window within which the second update should be performed at the first computing system;
identify a time overlap between the update-time window and the second update-time window; and
set the update time from within the time overlap.

17. The storage media of claim 16, wherein the program instructions direct the processing system to:
perform the second update at the first computing system at the update time.

18. The storage media of claim 16, wherein the update is applied to a different layer of a compute stack executing on the first computing system than the second update.

19. The storage media of claim 11, wherein the first computing system comprises a Software-Defined WAN (SD-WAN) edge.

20. An apparatus comprising:
one or more computer readable storage media;
a processing system operatively coupled with the one or more computer readable storage media; and
program instructions stored on the one or more computer readable storage media that, when read and executed by the processing system, direct the processing system to:
identify an update to be performed on computing systems connected to a Wide Area Network (WAN);
identify first attributes of a first computing system of the computing systems;
determine an update time in which the update should be performed at the first computing system based on the first attributes relative to other attributes of other ones of the computing systems; and
perform the update at the first computing system at the update time.
